(19) United States
(12) Patent Application Publication
(10) Pub. No.: US 2006/0143285 A1
(43) Pub. Date: Jun. 29, 2006

(54) Method and apparatus for location dependent software applications

(76) Inventor: Danny St-Denis, Windsor (CA)

Correspondence Address: HAYES, SOLOWAY P.C., 3450 E. SUNRISE DRIVE, SUITE 140, TUCSON, AZ, 85718, US

(21) Appl. No.: 11/360,833

(22) Filed: Feb. 23, 2006

Related U.S. Application Data
(62) Division of application No. 09/808,170, filed on Mar. 15, 2001.

(30) Foreign Application Priority Data
Mar. 15, 2000 (CA) 2,301,474
Sep. 22, 2000 (CA) 2,320,413

(51) Int. Cl. G06F 15/16

(52) U.S. Cl. 709/217

(57) ABSTRACT

The Internet provides tremendous opportunities location dependent services such as gaming and advertising. Gaming is geopolitically regulated, so the physical locations of the end user, the gambling server and the gambling service provider, must be determined. The invention provides a means for doing so, by identifying the location of the end user's Internet Service Provider (ISP) or Access Service Provider (ASP). Similarly, Internet advertising is presently either indiscriminate, which is inefficient, or is personalized, violating the end user's privacy. The invention allows advertising content to be provided based on the physical location of the end user's ISP. This way, advertisements can be geographically targeted without having personal records stored on the Internet. Also described are many other similar applications which can exploit knowledge of the user's geographical location by using the location of the end user's ISP or ASP.

The present invention relates generally to computers and communications, and more specifically, to a method and system of implementing location dependent software applications over computer networks.

### BACKGROUND OF THE INVENTION

It is well known that data communication networks such as the Internet, Wide Area Networks (WANs) and Local Area Networks (LANs), offer tremendously efficient means of organizing and distributing computerized data. These efficiencies have resulted in their widespread use for both business and personal applications. For example, the Internet is now a common medium for operating online auctions, academic and public forums, distributing publications such as newspapers and magazines, and performing electronic commerce and electronic mail transactions.

Two types of transactions for which the Internet appears particularly attractive are on-line gaming and advertising. As will be explained, proper implementation of these and similar application require the end user's location to be determined, Currently, the Internet does not offer a simple, inexpensive way of determining the end user's location.

Current gaming and betting systems typically require some manner of direct interaction in a common physical location, for example: casinos, bingo halls, video lottery terminals, sports betting halls and the like. However, it is not always possible for interested participants to visit such establishments, for example, people who are confined to a hospital or nursing home cannot physically attend a bingo session. Of course, operators of casinos and betting services would also like their clientele to have easier, twenty-four hour access to their services, which on-line systems would easily accommodate.

Because gambling is a regulated industry all over the world, one cannot simply create an on-line gambling site without regard for the regulations. These regulations are set by individual nations and vary from total prohibition to nearly complete permissive wagering on almost unlimited subject matter. In the United States, for example, the states have the authority to regulate gambling within their state borders. State-sanctioned lotteries, casinos, bingo halls, card parlours, and off-track paramutual betting on horse racing over the telephone are but a few examples. These activities are governed by a Gambling Commission in each state, who controls the licensing of all games and businesses permitted to offer games.

Internationally, the scene is much the same; that is, individual nation states regulate gambling within their borders. As no nation has successfully regulated gambling beyond its geopolitical boundaries, clearly telecommunication systems present the opportunity for regulatory problems.

In order to regulate and enforce the gaming industry, it is necessary to identify where the gambling occurs and who the parties are. This is of particular concern relative to remote gambling transactions made using a wide area communication network such as the Internet.

FIG. 1 presents an exemplary layout of an Internet communications system 30. The Internet 32 itself is represented by a number of routers 34 interconnected by an Internet backbone 36 network designed for high-speed transport of large amounts of data. User's computers 38 may access the Internet in a number of manners including modulating and demodulating data over a telephone line using audio frequencies, which requires a modem 40 and connection to the Public Switched Telephone Network 42, which in turn connects to the Internet 32 via an Internet Service Provider 44. Another manner of connection is the use of set top boxes 50 which modulate and demodulate data onto high frequencies which pass over existing telephone or television cable networks 52 and are connected directly to the Internet via Hi-Speed Internet Service Provider 54. Generally, these high frequency signals are transmitted outside the frequencies of existing services passing over these telephone or television cable networks 52.

Web sites are maintained on servers 56 also connected to the Internet 32 which provide content and applications to the user's computers 38. Communications between user's computers 38 and the rest of the system 30 are standardized by means of defined communication protocols.

Internet Service Providers (ISPs) 44, 54 or Internet Access Providers (IAPs), are companies that provide access to the Internet. ISPs 44, 54 are considered by some to be distinguished from IAPs in that they also provide content and services to their subscribers, but in the context of this disclosure the distinction is irrelevant. For a monthly fee, ISPs 44, 54 generally provider end users with the necessary software, user name, password and physical access. Equipped with a telephone line modem 40 or set top box 50, one can then log on to the Internet 32 and browse the World Wide Web, and send and receive e-mail.

FIG. 1 is something of a simplification, as ISPs are often connected to the Internet 32 through Network Access Points (NAPs), rather than directly as shown in FIG. 1. As well, the Internet itself is far more complex than that shown in FIG. 1, consisting of a vast interconnection of computers, servers, routers, computer networks and public telecommunication networks which allows two parties to communicate via whatever entities happen to be interconnected at any particular time. However, these details would be well known to one skilled in the art.

Prior to today's widespread accessibility to the Internet, remote gaming and betting had to be implemented in a “hard-wired” manner to ensure participants were located within an acceptable jurisdiction. This required the establishment of complicated and expensive secured virtual private networks (VPN), secure wide area networks (WAN), or private telephone lines. Such techniques are known in the art and will not be described in detail herein.

These hard-wired networks were costly and complex, and could not be easily setup or modified. Therefore, they could not be applied to participants with a casual interest in the gaming activity.

With the pervasiveness of the Internet, a large number of on-line gaming and betting services have recently appeared. Typically, these services use very weak techniques to verify the location of customers, which may explain why many of these services have located themselves beyond the legal reach of regulators in their main markets. For example, many on-line casinos directed towards the United States market are located in Antigua, Belize and Dominican Republic.

These systems generally ask the user to supply a street address which confirms they are currently in the acceptable jurisdiction. Some services even verify the end user's name, telephone number and address against a database to confirm that they should be allowed to use the service, but such controls can be circumvented simply by the end user entering a valid set of personal data for someone else in the acceptable area. Such approaches are therefore completely ineffective against a determined user.

It has been proposed that databases be created which will provide geographic locations based on the IP address of the user. In addition to the cost of creating and maintaining these databases, which would require continuous modification and updating, this approach requires the user's actual IP address, which raises privacy concerns. Furthermore, many dial up ISPs use Dynamic Host Configuration Protocol (DHCP) which dynamically assigns IP addresses to subscribers when they call up. Therefore, a device can have a different IP address every time it connects to the network, and In some systems, the device's IP address can even change while it is still connected.

DHCP simplifies network administration because the software keeps track of IP addresses rather than requiring an administrator to manage the task. This means that a new computer can be added to the network without the inconvenience of manually assigning it a unique IP address. Because the end user is not associated with a unique IP address, the IP address does not reliably correspond with the geographic location of an end user.

Another approach is to use the existing global positioning system (GPS) to identify the geographic location of end users. The GPS is a system of 24 satellites for identifying earth locations, launched by the U.S. Department of Defense. By triangulation of signals from three of the satellites, a receiving unit can pinpoint its current location anywhere on earth to within a few meters. However, such systems require the end user to install special, expensive hardware and software. Since the GPS equipment is on the end user's premises and out of control of the regulators, it may be subject to tampering. An end user could, for example, alter the data the GPS equipment provides to indicate that he is residing in any jurisdiction that he wishes.

It has also been proposed that IPv6 be designed to accommodate location information. IPv6 is the next generation IP protocol, which among other things, expands the address space from 32 to 128 bits. Therefore, the address space has sufficient room to include both a backward compatible IP address, as well as geographic data. However, this would require universal agreement or standardization, which has not occurred. As well, IPv6 has not been widely implemented, and will likely require some time to replace the currently pervasive IPv4 legacy hardware and software.

If the above problems could be overcome, geographical locating could be used for far more than simply gaming and betting. For example, any services which a Web site wishes to restrict to end users in a certain geographic area may be so restricted, including government publications, help lines or counselling services. As well, any content which is of regional interest could be distributed, including local news, stock quotations, weather reports, road conditions and public meetings. The system could also determine which state and national taxes apply to the sale of goods by determining the location of the buyer and seller.

For example, the Internet is an excellent medium for advertising because of the rich formatting, including sound, animation and personal interaction with the end user. As well, the Internet is pervasive in developed countries and the cost of making advertising content available once it is created, is minimal. The hardware and software used to implement the Internet, as well as the content that is carried, all have a cost. In many other media, such as television and radio, the cost to end users is nominal because advertisers pay for most of the cost of the infrastructure. However, there are no effective ways of managing advertising over the Internet.

While the Internet is an international communication network, advertising and much other content has only local value. Hence, in order for advertising to be effective, some efficient manner of targeting advertising to users based on their geographical location is required. Like the location determining techniques used in gaming applications, none are effective.

There is therefore a need for a means of determining the geographic location of end users over the Internet and similar networks, provided with consideration for the problems outlined above.

### SUMMARY OF THE INVENTION

It is therefore an object of the invention to provide a method and system which obviates or mitigates at least one of the disadvantages described above.

One aspect of the invention is broadly defined as a method of gaming over a communication network comprising the steps of: an end user sending a request to an Internet Service Provider (ISP) for access to a gaming Web site; the ISP forwarding the request to a Gaming Server for the gaming Web site, including ISP location data; and the Gaming Server responding to the ISP being in an acceptable location by allowing access to the gaming Web site.

Another aspect of the invention is defined as a system for targeted distribution of content over a communication network comprising: an end user; an Internet Service Provider (ISP); a Gaming Server having a gaming Web site; and a communication network for interconnecting the end user, the ISP and the Gaming Server; the end user being operable to: send a request to an Internet Service Provider (ISP) for access to the gaming Web site; the ISP being operable to: forward the request to the Gaming Server, including ISP location data; and the Gaming Server being operable to: respond to the ISP being in an acceptable location by allowing access.

One aspect of the invention is broadly defined as a method of targeted distribution over a communication network comprising the steps of: an end user sending a request to an Internet Service Provider (ISP), for a Web page from a Web Site; and the ISP returning the Web page to the end user, including targeted content based on the location of the ISP.

Another aspect of the invention is defined as a system for targeted distribution of content over a communication network comprising: an end user; an Internet Service Provider (ISP); and a communication network for Interconnecting the End user and the ISP; the end user being operable to: send a request to the Internet Service Provider (ISP) for a Web page; and the ISP being operable to: return the Web page to the end user, including targeted content based on the location of the ISP.

### BRIEF DESCRIPTION OF THE DRAWINGS

These and other features of the invention will become more apparent from the following description in which reference is made to the appended drawings in which:

FIG. 1 is a physical layout of an exemplary communication network as known in the prior art;

FIG. 2 is a flow chart of a method of gaming in a preferred embodiment of the invention;

FIG. 3 is a block diagram of a system of gaming in a preferred embodiment of the invention;

FIG. 4 is a flow chart of a method of gaming in a preferred embodiment of the invention;

FIG. 5 is a flow chart of a method of targeted distribution of advertising in a preferred embodiment of the invention;

FIG. 6 is a block diagram of a system of targeted distribution of advertising in a preferred embodiment of the invention; and

FIG. 7 is a flow chart of a method of targeted distribution of advertising in a preferred embodiment of the invention.

### DETAILED DESCRIPTION OF PREFERRED EMBODIMENTS OF THE INVENTION

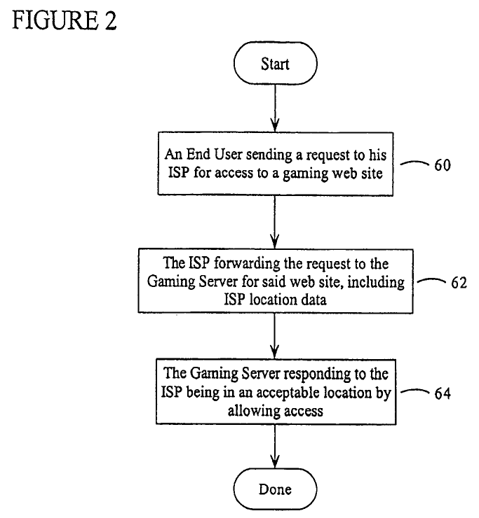

A methodology which addresses the objects outlined above, is presented as a flow chart in FIG. 2. This figure presents a method of gaming over a communication network which is initiated when an end user sends a request to an Internet Service Provider (ISP) to access a gaming Web site at step 60. The ISP forwards this request to the Gaming Server which supports the gaming Web site at step 62, but also includes ISP location data with this request. This ISP location data allows the Gaming Server at step 64 to check the location of the ISP and allow access to the gaming Web site if the ISP is in an acceptable location.

The communication network may be one of many known in the art, and may consist of several different networks working together, including wireless networks such as cellular telephone networks, the public switched telephone network, cable television networks, the Internet, ATM networks, frame relay networks, local area networks (LANs) and wide area networks (WANs).

The end user may send his request to his ISP using a number of different devices including a computer, smart terminal, personal digital assistant, Internet-ready telephone, a dedicated gaming device or other similar interface. Such devices are well known in the art.

The gaming Web site could be similar to one known in the art, and could include text, graphics, audio files, executable applets, data files or attachments such as software files, or other data and files known in the art. The gaming content is not limiting on the invention, and could include, for example, amusement games, games of chance or betting systems. Additional examples are described hereinafter.

The ISP may obtain the gaming Web site data from a number of sources, though generally it will be from the Gaming Server maintaining the Web site. Often, however, the same content may be available in a memory cache on the ISP's equipment, or in a similar cache elsewhere on the communication network. As well, the gaming Web sites may have mirror sites to which the request may be directed.

In order to entitle the end user to commence legal gambling or betting, the regulators having jurisdiction over the end users and the casino must be established. Jurisdiction is established by determining the physical locations of the casino, the player and possibly the server. The location of the casino is known, and the location of the server is controlled by the casino. What must be specifically determined is the location of the player.

The invention verifies the location of the end user by identifying the location of the Internet Service Provider (ISP), or Internet Access Provider (IAP). While there is a distinction between an ISP and ASP in the art, the distinction is not significant for the purposes of the invention. As the ISP controls the manner in which the end user makes his physical connection to the Internet, he will be in a position to determine whether the end user's physical location can be confirmed sufficiently to allow access. Methods of determining the end user's physical location and methods for communicating the ISP's position are described in greater detail hereinafter.

The invention of FIG. 2 addresses the problems in the art. It allows remote users to legally gamble at legal casino sites using a common and inexpensive communications network such as the Internet, as the connecting medium.

No additional hardware is required as in the case of the GPS solutions, and DNS routers do not need to be modified to include location data. Therefore, there is no additional cost to the end user and the invention may be applied without affecting the existing network. As well, the invention is independent of whether IPv4 or IPv6 is being used.

Because the targeting is determined by the location of the ISP and does not require the IP address of the end User, the Invention also operates with Dynamic Host Configuration Protocol (DHCP) systems. As well, because the determination of location is made by the ISP, there is no opportunity for the end user to tamper with the verification process.

Thus, the invention allows twenty-four hour a day, seven day a week gaming and amusement services without the inconvenience of having to attend a physical location. As well, regulators' requirements can easily be accommodated. The invention offers many other advantages, which would be clear to one skilled in the art. For example, it allows organizations using casinos to launder money, to easily be identified and monitored.

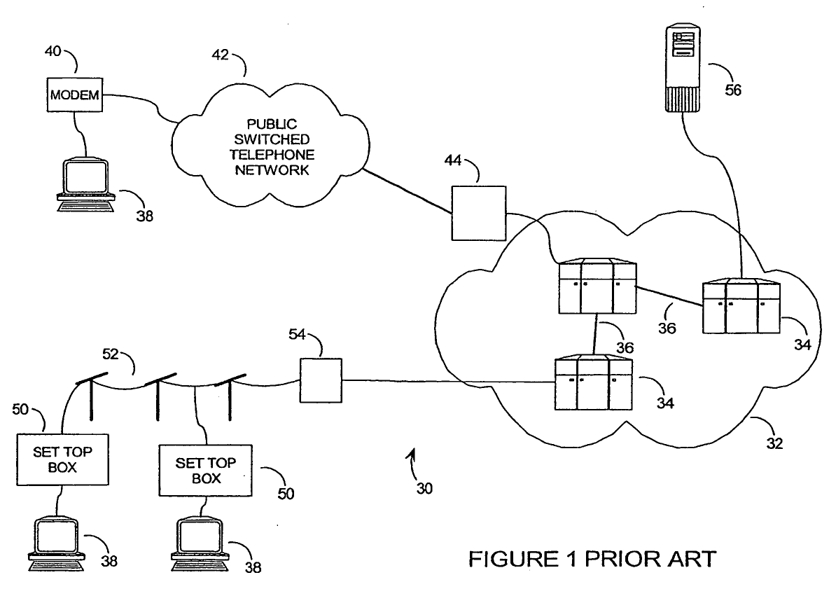

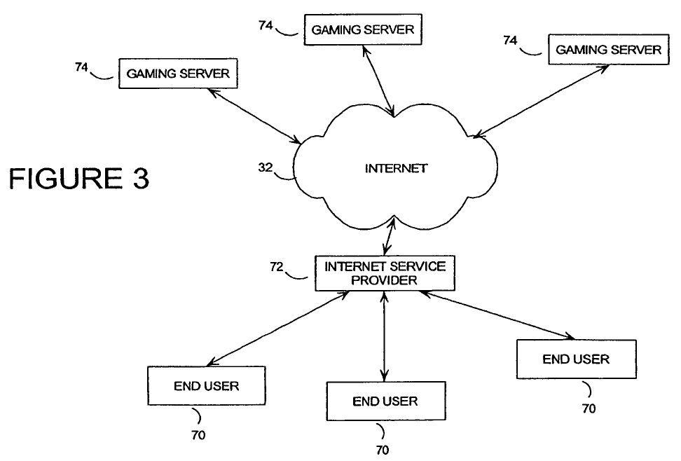

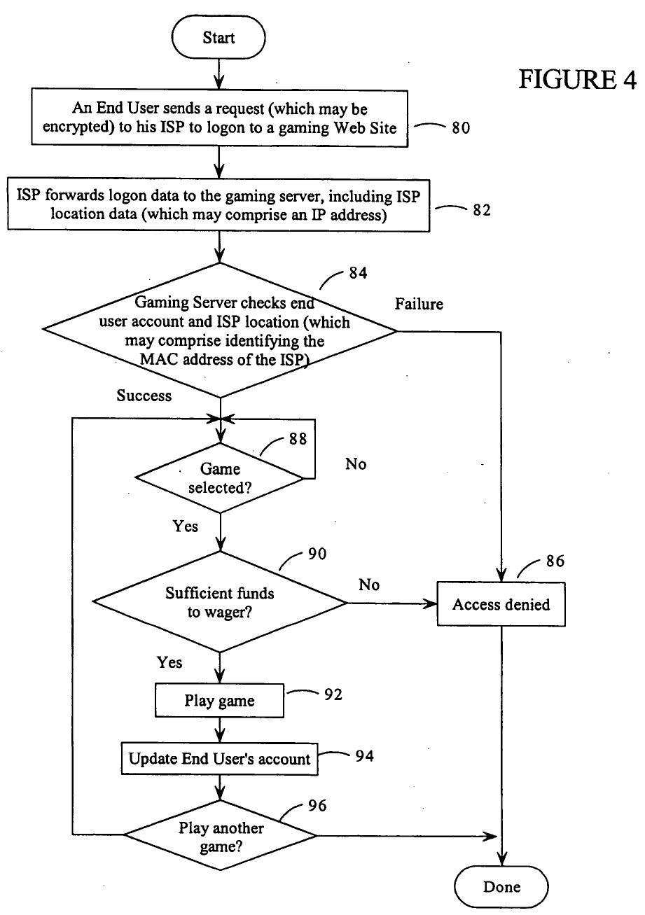

The preferred embodiment of the invention is presented by means of the block diagram in FIG. 3, and the flow chart of FIG. 4. FIG. 3 focuses on the relevant parties in the transaction of the invention, and does not present the same level of detail as FIG. 1.

A number of end users 70 are presented, who have access to the Internet 32 via their ISP 72. The end users 70 may employ computers 38 as in FIG. 1, or other interface devices as known in the art, and as will emerge as technology evolves. These end users 70 may access their ISP 72 in different ways, such as via cable modem, telephone line mode, or wireless methods, which is not limited by the invention. Via the Internet 32, the end users 70 then have access to various gaming servers 74, who provide them with the software code to effect online gaming.

The corresponding method of the invention is presented as a flow chart in FIG. 4. This method is initiated by an end user logging onto a Gaming Server's 74 Web site at step 80. This step will generally be effected by the end user searching through the resources of the World Wide Web, using his Web browser. A Web browser is an application program that runs on the end users computer 38 and provides a way to look at and interact with all the information on the World Wide Web. A Web browser uses HTTP to make requests of Web servers throughout the Internet on behalf of the Web browser user. Currently, most Web browsers are implemented as graphical user interfaces.

When the end user enters file requests by either “opening” a Web file, typing in a Uniform Resource Locator (URL), or clicking on a hypertext link, the Web browser builds an HTTP request and sends it to the Internet Protocol address indicated by the URL. The HTTP software in the destination server machine receives the request and, after any necessary processing, the requested file is returned.

The Hypertext Transfer Protocol (HTTP) is the set of rules for exchanging files on the World Wide Web, including text, graphic images, sound, video, and other multimedia files. HTTP also allows files to contain references to other files whose selection will elicit additional transfer requests (hypertext links). Typically, the HTTP software on a Web server machine is designed to wait for HTTP requests and handle them when they arrive.

The details of the login step may vary from application to application, and are well known in the art. In the preferred embodiment of the invention, the following would be included:
1. the end user either types in the uniform resource locator (URL) of the casino Web site, clicks on a previously bookmarked URL, or clicks on a hypertext link from another Web site, to reach the home page of the gaming Web site;
2. the Gaming Server 74 on which the gaming Web site resides, returns the main Web page to the end user;
3. the end user selects the login page on the gaming Web site;
4. the Gaming Server 74 returns the login page, requesting that the end user enter his account and password, or similar secure identification such as a personal identification number (PIN) or digital signature; and
5. the end user returns the requested login information to the Gaming Server 74.

Next, at step 82, the ISP 72 receives the login response from the end user and forwards it to the Gaming Server 74, including ISP location data.

The physical location of the ISP 72 may be determined at step 82, in a number of manners including the following:

1. Indication by ISP 72

Of course, the ISP 72 could simply identify its physical location to the gaming server when it places its request. To streamline the process, the gaming server could standardize the references, rather than using latitude and longitude, it could for example, provide listings of towns, cities and counties that the ISP 72 associates itself with.
   2. IP Address
Internet Protocol (IP) addresses are identifiers for computers or devices on an Internet network, which are used to route messages. The format of an IP address in IPv4 is a 32-bit number which consists of a network prefix, and a host number. In “subnet” networks, the 32-bits are shared with a third component—the “subnet number”.
The network prefix, or network prefix and subnet number In combination (sometimes referred to as the extended network prefix), identifies the ISP 72, or at least its network access point (NAP). Therefore, this information can be used to identify the physical ISP that an end user is connected to. With this information, the gaming server 74 can send the proper regional content to the end user.
The number of unassigned Internet addresses is running out, so a new “classless” scheme called Classless Inter-Domain Routing (CIDR) is gradually replacing the system based on classes A, B, and C and is tied to adoption of IPv6. With CIDR, IP addresses still have a network prefix and subnet number, but the formatting has changed. Therefore, the invention can be applied to CIDR just as easily as the existing IP class system.
   3. MAC or DLC Address
In networks, a node is a processing location, and can be a computer or some other device, such as a printer. Every node has a unique network address, sometimes called a Data Link Control (DLC) address or Media Access Control (MAC) address.
A Media Access Control (MAC) address is a hardware address that uniquely identifies each node of a network. In IEEE 802 networks, the Data Link Control (DLC) layer of the OSI Reference Model is divided into two sublayers: the Logical Link Control (LLC) layer and the Media Access Control (MAC) layer. The MAC layer interfaces directly with the network media.
On networks that do not conform to the IEEE 802 standards but do conform to the OSI Reference Model, the node address is called the Data Link Control (DLC) address.
If the ISP 72 does not transmit its physical address in its request, the gaming server may use the Address Resolution Protocol (ARP) to convert the IP address into a physical address, such as a DLC address. The gaming server wishing to obtain a physical address broadcasts an ARP request onto the Internet. The server on the network that has the IP address in the request (the ISP 72 in this case) then replies with its physical hardware address.

At step 84, the gaming server 74 authenticates the players identity (via the account and password for example), and confirms that the ISP 72 lies within the acceptable jurisdiction, using a method complementary to that used in the method at step 82.

Note that if the ISP 72 allows telephone dial-up access which an end user could access from another jurisdiction by long distance dialling, for example, the ISP 72 may simply use call display to confirm the dialled number. If an end user is outside the jurisdiction, the ISP 72 may then allow the end user regular access to the Internet 32, but reject logon attempts to gaming sites.

If the end user attempts to access the gaming Web site by reaching his ISP 72 using a cellular telephone, the ISP 72 may verify the location of the end user by identifying the cellular tower serving the end user. Such technology is known in the art. Cellular systems are local systems. As a car travels from one cell to the next, the cellular network tracks the user in order to maintain the communication, and necessarily knows which cell the user is in. As Web sites would recognize the MAC address of the cellular provider, the MAC address must be verified as the end user moves from one cell to the next.

If the logon attempt at step 84 fails, the Gaming Server 74 returns an “access denied” message at step 86 and the routine is complete.

If authentication is successful then the routine proceeds to perform whatever steps are necessary to effect the desired game, at steps 88 through 94. These steps will vary widely, but may include:
the end user being prompted to select a game and making such a selection at step 88. Typically, the software routine will sit in a loop until such a selection is made;
the Gaming Server 74 then determines whether the end user has sufficient funds to play the requested game at step 90. If not, access is denied at step 86, otherwise, control passes to step 92;
the game is then played at step 92. This may include many steps, as known in the art;
after the completion of the game, at step 94, the gaming server makes whatever adjustments are necessary to the end users account, crediting or debiting his account in respect of the wins or losses in the game. Generally, these accounts are managed using debit cards and credit cards, but many other systems could be used such as prepaid accounts or smart cards.

As the game is completed, the end user is queried as to whether he wishes to play another game at step 96.

The invention has been described with respect to a specific example, but it would be clear to one skilled in the art that the invention may be applied to many amusement games, games of chance, for betting or entertainment purposes, including without limitation: video lottery terminals, keno, roulette, dice games such as craps, ma jong, jai lai, pai gow, horse racing, dog racing, lotteries, slot machines, baseball, football, golf, basketball, fantasy sports leagues and fantasy sports games, and card games which may include poker, black jack, solitaire, and baccarat. The invention may, for example, be used to collect participants in different geographical areas to compete against one another as teams.

Geographical locating in the manner of the invention could also be used for far more than simply gaming and betting, in fact any services which a Web site wishes to restrict to end users in a certain geographic area may be so restricted. As noted above, these services may include for example: government publications, help lines or counselling services. The system could also determine which state and national taxes apply to the sale of goods by determining the location of the buyer and seller.

Large parts manufacturers in the automotive and aerospace industries could use the invention to route parts to distributors on a geographic basis, or for added security. The large automobile manufacturers intend to implement an online parts distribution system in which different types of customers have different levels of access. The invention could be applied to such a scenario, for large or small parts, by verifying the location and integrity of the source and customer requesting the parts.

As noted above, advertising is another application for which location dependent processing is desirable.

Targeted Advertising

Typically, advertising on the Internet today is non-discriminant. The same advertisements are presented to any end user who accesses a given Web page, regardless of who they are or where they are. Some Web pages have a large number of advertisements that are cycled through, so that a different advertisement may appear each time one accesses the page, but again, this is done in a non-discriminant basis.

Obviously, this approach is not efficient, as some viewers will not be in the geographic marketing area of the advertiser, which may be limited to a continent, country or region. While it is known how to monitor the number of end users who have viewed a Web page or an advertisement, it is not possible to determine how many of those end users are part of the targeted group. Therefore, this method of advertising has questionable commercial value.

Some Web sites monitor the preferences of end users accessing their Web sites, and record those specifics. One method of doing this is to collect “cookies” from end users. Cookies are messages given to a Web browser by a Web server when the end user accesses that Web server, which the browser stores in a text file.

The cookie is then sent back to the Web server each time the Web browser requests a Web page from the Web server.

The main purpose of cookies is to identify end users and possibly prepare customized Web pages for them. However, the creation of user preference databases are generally considered by the public to be an invasion of privacy, so there is pressure to create laws or apply existing laws to prevent such monitoring. Such monitoring has also encouraged the development of anonymous servers, which serve as intermediaries to disguise end users from the Web sites they wish to access.

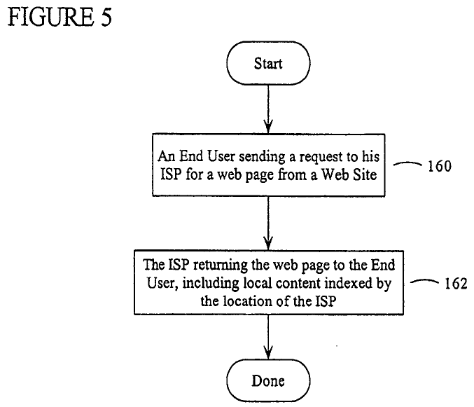

A methodology which allows for location-targeted advertising, without the problems noted herein above, is presented as a flow chart in FIG. 5. This figure presents a method of targeted distribution over a communication network which is initiated when an end user sends a request to his Internet Service Provider (ISP) for a Web page at step 160. The ISP returns the requested Web page to the end user at step 162, including targeted content based on the location of the ISP, rather than the location of the end user.

As in the gaming embodiment above, the communication network may be one of many known in the art, and may consist of several different networks working together. The end user may send his request to his ISP using a number of different devices including a computer, smart terminal, personal digital assistant, Internet-ready telephone or other similar interface. Such devices are well known in the art.

The Web page that has been requested is not intended to limit the claimed invention, and could include text, graphics, audio files, executable applets, data files or attachments such as software files, or other data and files known in the art.

The ISP may obtain the Web page from a number of sources, though generally it will be from the Web Site maintaining the page. Often, however, the same content may be available in a memory cache on the ISP's equipment, or in a similar cache elsewhere on the communication network. As well, Web Sites may have mirror sites to which the request may be directed.

Once the ISP obtains the Web page data, it inserts targeted content which is determined by the location of the ISP itself. The targeted content will most likely include advertising, but may also include other information of regional interest, including road maps, weather reports, local news and announcements, stock quotations and public meetings. As well, geographical targeting could be used to tailor the language used on a Web site or portal to the local requirements. Yahoo, for example, could default to send English Web pages to ISPs in North America, and German Web pages to ISPs in Germany. This information may be stored on the ISP's equipment, or obtain from any other location accessible over the communication network.

The invention of FIG. 5 addresses the problems in the art. It allows advertisements and other content to be directed geographically, which makes such advertising far more effective and should address the cost issues which presently hinder growth of the Internet.

As in the case of the gaming application, no additional hardware is required as in the case of the GPS solutions, and DNS routers do not need to be modified to include location data. There is no additional cost to the end user and the invention may be applied without affecting the existing network. As well, the invention is independent of whether IPv4 or IPv6 is being used.

Because the targeting is determined by the location of the ISP and does not require the IP address of the end User, the invention also operates with Dynamic Host Configuration Protocol (DHCP) systems.

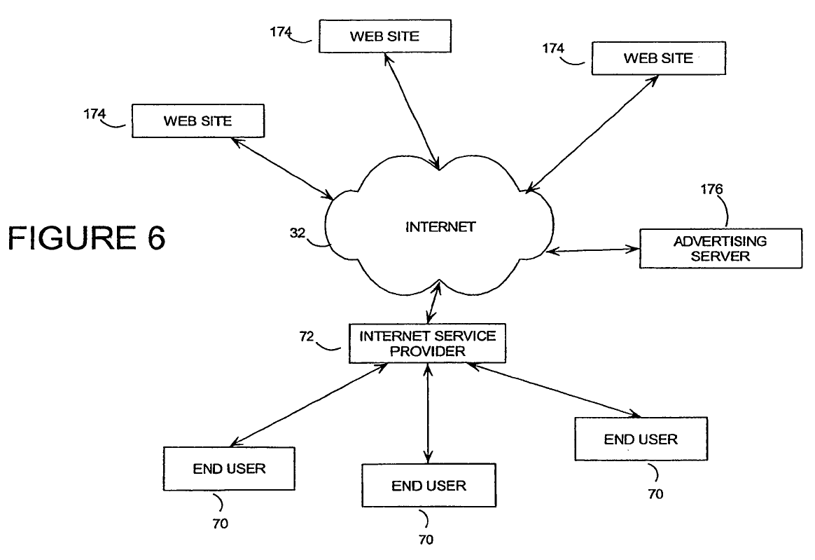

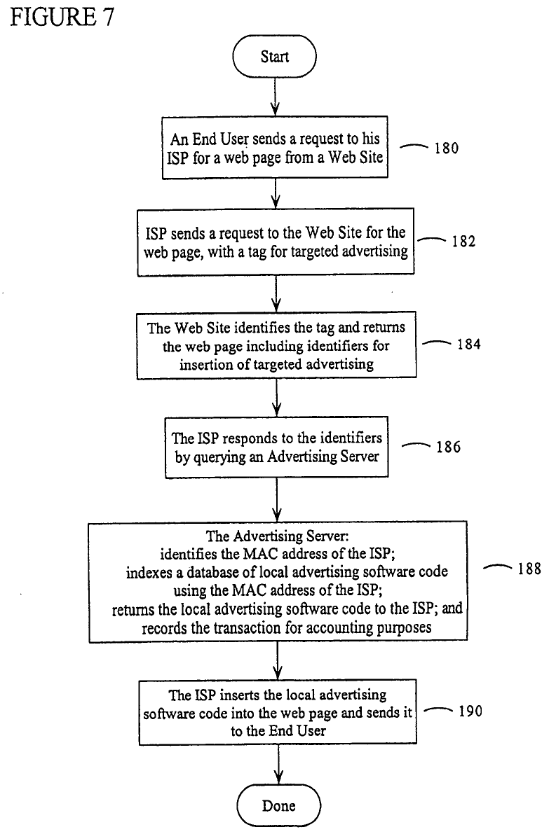

The preferred embodiment of the invention is presented by means of the block diagram in FIG. 6, and the flow chart of FIG. 7. FIG. 6 identifies the relevant parties in the transaction of the invention, and does not present the same level of detail as FIG. 1.

As in FIG. 3, this system includes a number of end users 70 who have access to the Internet 32 via their ISP 72. The end users 70 may employ computers 38 as in FIG. 1, or other interface devices as known in the art, and as will emerge as technology evolves. These end users 70 may access their ISP 72 in different ways, such as via cable modem, telephone line mode, or wireless methods, which is not limited by the invention.

Via the Internet 32, the end users 70 then have access to various Web Sites 174, who provide them with Web pages and other content. The Web Sites 174 and ISP 72 also have secure access to an advertising server 176 which stores the regional content. The advertising server 176 is described in greater detail hereinafter.

The corresponding method of the invention is presented as a flow chart in FIG. 7. This method is initiated by the end user 70 sending a request to an Internet Service Provider (ISP) 72, for a Web page from a Web Site 174, at step 80. This step will generally be effected by the end user 70 searching through the resources of the World Wide Web, using his Web browser as described above with respect to FIG. 4.

Next, at step 182, the ISP 72 receives the request from the end user 70 and sends a request to the Web Site 174 with a tag indicating that targeted advertising is to be applied.

The Web Site 174 identifies the tag and returns the requested Web page with identifiers in place of the usual advertising that they generate themselves, at step 184. As well, this Web page still has the targeted advertising tag Intact.

When the Web page with the tag is received by the ISP 72, it responds at step 86 by querying an advertising server 176 to obtain the local advertising software code, or other regional content.

The local advertising server 176 responds at step 188 by:
1. identifying the physical location of the ISP 72;
2. indexing a database of advertising software code or other regional content, using the physical location of the ISP 72;
3. returning the advertising software code to the ISP 72; and
4. recording the transaction for accounting purposes.

Upon receipt of the local advertising software code at step 190, the ISP 72 simply inserts the software code into the Web page and sends it to the end user 70.

As described above, the physical location of the ISP 72 may be determined at step 182, in a number of manners including an indication by the ISP 72, use of the IP Address of the ISP 72, or use of its MAC or DLC Address.

The invention is not limited by the nature of the Web page being transmitted. The invention could be used to insert simple banners into Web pages, or more sophisticated multimedia advertisements. As well, these advertisements could be sent along with real audio, real video, telephone over Internet, video conferencing over Internet, or other data and software applications. Like the gaming embodiment, the advertising embodiment could also be applied to cellular wireless applications, with advertising changing as the end user 70 moves from one cell to the next.

In the preferred embodiment, an advertising server 176 is used which will administer advertising in an effective and secure manner, accounting for the financial agreement between the various Web Server and ISPs. However, the Web site may perform this functionality itself, in fact, it may implement the invention without the knowledge of either the ISP 72 or the end user 70. Alternatively, the ISP 72 could replace advertising in Web pages received from Web Sites with its own content, or simply add its own advertising banners or headers to Web pages.

Additional Embodiments

The system and method of the invention may also be applied in many other manners, which would be clear to the skilled technician from the teachings herein. For example:
1. Correlating web page accesses with geographic areas allows valuable marketing and statistical data to be easily collected.
2. The distribution of movies can be better controlled to increase their viewing rates. Rather than making a complete collection of movies available to all users at one time, in which case users will only view the best ones, the method of the invention can be used to roll out certain movies in certain areas, at certain times. A movie distributor could, for example, roll out ten new movies each month, encouraging users to fall into a pattern of viewing new movies as they are released. The controlled release makes it easier to market the movies.
By rolling out movies in different regions at different times, public interest and anticipation can be built, increasing demand.
The same technique can be used for other electronic content or on-line applications such as music and video games.
3. A movie distributor could also avoid making certain movies available in certain areas, to manage public image. For example, a producer of family movies may be concerned that releasing a risque movie in a religious region may damage their reputation, while it might be overlooked in another area. With the invention, the movie distributor could release the movie in some regions and block it in others.
4. The Invention could be used to enforce publication bans in court cases.
5. The invention allows entertainment content to be distributed far more efficiently to smaller markets. Currently, movies are only produced if they have very broad appeal. The invention would allow a documentary to be produced on the Walkerton water treatment scandal, for example, and be marketed and distributed in the area that has an interest in the product, rather than nationwide or internationally. Web portals in the region of interest could be provided with the marketing material, while web page requests from users outside the targeted jurisdiction would receive marketing content appropriate to their own area.
6. Like gaming, censorship is also generally regulated by geopolitical region.

The invention would allow censorship of video, text, audio and audio/visual content by correlating the end user's location with a censorship database or flags within the web pages providing the content.
Some measure of protection would be required to prevent users from downloading content inside an area in which certain content Is allowed, and re-distributing it into an area in which it is censored. Such techniques are known in the art.
7. Language laws may be enforced using the invention. If for example, a particular province or state requires business to be carried out in a particular language, then the invention can identify requests coming from users in that state and only return web pages that comply with those language requirements.
Similarly, the invention may be used to identify the default language for the end user. For example, it may be assumed that all users in United States will be able to read English, so English web pages would be returned to users in the United States by default.
8. Prices for electronic commerce (e-commerce) products and services can be presented to users in their local currency, using local prices sheets, and taking into account shipping and/or handling costs to reach that locale.
9. Encryption software is also controlled by geopolitical regions. The United States, for example, does not allow export of certain strong encryption software in an effort to prevent foreign organized crime from obtaining access to secure communication. The method of the invention could be used to enforce such laws.
10. Marketing can be regionalised. For example, electronic sales flyers and brochures may be targeted on a geographic basis, so that they include prices and products which vary from region to region.
11. The invention allows marketing techniques which communicate a higher level of “trust” than traditional Internet marketing techniques. For example, the web page of a large bank may be tailored for each branch, on a geographic basis, so that users believe they are communicating with the local bank, rather than a nation-wide server.
12. Sports content can be tailored by geographic region. For example, hockey may be assumed to have higher priority in Canada, and baseball, a higher priority in United States. If a small-town fastball team is playing in the state finals, it may be assumed that this will be of interest to users in the small town but not to users in other states. Thus, web portals, menus and web pages in general may be tailored for regional content using the invention.

On-line software applications and operating systems could tailor functionality based on location, using a number of the concepts outlined above. Parameters of an on-line operating system that could be modified by geographic location could include: encryption techniques (see item 9 above), language (see item 7), advertising and marketing materials, and identification of national and state holidays in a calendar application. Default spelling of words could also be determined by geographical location. The word “colour”, for example, is typically spelled “color” in United States and “colour” in Canada.

In the preferred embodiment of the location dependent processing applications, all Internet communications are to be encrypted as a security precaution, using one of many techniques known in the art. Currently, the preferred method is that of public-key/private-key encryption. Encryption preserves the privacy of the transactions, prevents tampering with the game or results, and protects against unauthorized access to a players financial accounts.

The method steps of the invention may be embodiment in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory medium such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

The invention could, for example, be applied to computers, smart terminals, personal digital assistants and Internet-ready telephones. Again, such implementations would be clear to one skilled in the art, and do not take away from the invention.

1-10. (canceled)

11. A method of targeted distribution of content over a communication network comprising the steps of:
an end user sending a request to an Internet Service Provider (ISP) or Internet Access Provider (IAP) for a Web page; and
said ISP returning said Web page to said end user, including targeted content based on the location of said ISP or IAP.

12. A method as claimed in claim 11, wherein said step of returning comprises the step of:
said ISP or IAP querying an advertising server for local advertising software code;
said a local advertising server responding to said query by:
identifying the physical location of the ISP or IAP;
indexing a database of advertising software code using said physical location; and
returning said advertising code to said ISP or IAP; and
said ISP or IAP inserting said local advertising software code into said Web page and sending said Web page to said end user.

13. A method as claimed in claim 12, wherein said step of identifying the physical location of the ISP or IAP comprises the step of:
identifying the physical location of the ISP or IAP based on the MAC address of said ISP or IAP.

14. A method as claimed in claim 12, wherein said step of identifying the physical location of the ISP or IAP comprises the step of:
identifying the physical location of the ISP or IAP based on the IP address of said ISP or IAP.

15. A method as claimed in claim 12, wherein said step of identifying the physical location of the ISP or IAP comprises the step of:
identifying the physical location of the ISP or IAP based on an address indicated by said ISP or IAP.

16. A method as claimed in claim 11, wherein said step of returning comprises the step of:
said ISP or IAP sending a request to said Web Site with a tag identifying said request for targeted advertising; and
said Web Site, responding to said request for a Web page and to said request including said targeted advertising tag, by returning said Web page to said ISP or IAP, said Web page including identifiers for the insertion of advertising code.

17. A method of targeted advertising comprising the steps of:
an end user sending a request to an Internet Service Provider, for a Web page from a Web Site;
said ISP or IAP sending a request to said Web Site with a tag identifying said request for targeted advertising;
said Web Site, responding to said request for a Web page and to said request including said targeted advertising tag, by returning said Web page to said ISP or IAP, said Web page including identifiers for the insertion of advertising code;
said ISP or IAP responding to the receipt of said Web page with said identifiers by querying an advertising server for local advertising software code;
said a local advertising server responding to said query by:
identifying the MAC address of the ISP or IAP;
indexing a database of advertising software code using said MAC address;
returning said advertising code to said ISP or IAP; and
recording said transaction for accounting purposes; and
said ISP or IAP inserting said local advertising software code into said Web page and sending said Web page to said end user.

18. A system for targeted distribution of content over a communication network comprising:
an end user;
an Internet Service Provider (ISP) or Internet Access Provider (IAP); and
a communication network for interconnecting said End user and said ISP or IAP;
said end user being operable to:
send a request to said Internet Service Provider (ISP or IAP) for a Web page; and
said ISP or IAP being operable to:
return said Web page to said end user, including targeted content based on the location of said ISP or IAP.

19-20. (canceled)
